(19) United States
(12) Patent Application Publication
(10) Pub. No.: US 2022/0007810 A1
(43) Pub. Date: Jan. 13, 2022

(54) BLADELESS EXFOLIATION HEAD, HANDHELD SKINCARE DEVICE AND SHAVING KIT

(71) Applicant: Bic Violex S.A., Anoixi (GR)

(72) Inventors: Georgios PASPATIS, Anoixi (GR); Panagiotis MOUSTAKAS, Anoixi (GR)

(73) Assignee: Bic Violex S.A., Anoixi (GR)

(21) Appl. No.: 17/293,642

(22) PCT Filed: Nov. 26, 2019
(86) PCT No.: PCT/EP2019/082593

§ 371 Date: May 13, 2021

(30) Foreign Application Priority Data
Nov. 29, 2018 (EP) 18209078.7

(51) Int. Cl. A45D 26/00; B26B 21/52; A45D 27/00; A61H 7/00

(52) U.S. Cl. CPC A45D 26/0004; B26B 21/521; A45D 2200/1054; A61H 7/003; A45D 2200/25; A45D 27/00

(57) ABSTRACT

A bladeless exfoliation head may be for a handheld skincare device. The exfoliation head may include a main body. The main body may support an exfoliation body and an interface for detachably connecting to a handle. The exfoliation body may be less rigid than the main body. The main body may include one or more exfoliation features. The one or more exfoliation features may be disposed on an exfoliation surface of the exfoliation body. The exfoliation surface may be opposite the exfoliation head from the interface. The exfoliation head may be provided in a skincare kit or even a shaving kit.

### CROSS REFERENCE TO RELATED APPLICATIONS

This application is a National Stage Application of International Application No. PCT/EP2019/082593, filed on Nov. 26, 2019, now published as WO/2020/109307 and which claims priority to European Patent Application No. EP18209078.7, filed on Nov. 29, 2018, entitled “BLADELESS EXFOLIATION HEAD, HANDHELD SKINCARE DEVICE AND SHAVING KIT”, the entire contents of which are incorporated herein by reference.

### FIELD

The present description relates to the field of skincare, and in particular to shaving. More specifically, the present description relates to a handheld skincare device, a bladeless exfoliation head therefor, and a shaving kit including such a bladeless exfoliation head.

### BACKGROUND ART

A common issue in the shavers field is skin irritation brought on by the shaving process. One cause of this irritation can be ingrown hairs in the skin. Ingrown hairs often cause an inflammatory immune reaction that can result in razor bumps, keloid scarring, discoloration, and even infection. A number of means for preventing these irritations while maintaining a smooth, clean-shaven look have been available.

For example, mechanical exfoliation is a skin care practice that enhances the removal of dirt, surface bacteria, dead skin cells, and sebum from the skin surface and also enables the release of trapped hair preventing bumps.

To combat irritation during shaving, U.S. Pat. No. 7,367,125B2 discloses a razor handle supporting a housing that contains both an exfoliation member and a blade member, so that dragging the blade across the skin concurrently causes the exfoliation member to be dragged across the skin, and vice-versa.

Performing these two functions (exfoliation and shaving) concurrently has not proved to be an effective method.

US2010217263 shows an example of an automated hair removal system. The system includes a handheld device having an electric motor for rotating an attachment holder, the attachment holder including a head attachment mechanism for receiving an attachment head. The system further includes an attachment head having a contact surface configured for skin contact, the attachment head further having a holder attachment mechanism for detachably attaching the attachment head to the attachment holder. Rotation of the attachment holder by the electric motor causes rotation of the attachment head and the contact surface, and wherein rotation of the contact surface upon placement against the skin essentially in parallel to the skin and transverse to hair thereon, removes hair from the skin by tapering and weakening the structure of the hair.

WO2008099343A1 shows another example of a shaving system comprises a handle, a first head, a second head and a third head. The handle comprises a power source and a head attachment member. The first head comprises a rotating member. The first head is attachable to the handle by the head attachment member. The power source supplies power to the first head to rotate the rotating member. The second head comprises a plurality of razor blades. The second head is attachable to the handle by the head attachment member. The third head is also attachable to the handle by the head attachment member. The third head comprises a compartment for housing an after shave solution. The third head comprises a port for delivering the after shave solution to a user's skin.

### SUMMARY

The inventors have recognized that benefits of exfoliation are obtained when it is performed prior to shaving. It is therefore a goal of the present invention to prevent shaving-related irritation by offering exfoliation which is both convenient and effective.

According to examples of the present disclosure, a bladeless exfoliation head may be provided. The exfoliation head may be for a handheld skincare device. The exfoliation head may include a main body. The main body may support an exfoliation body and an interface for detachably connecting to a handle. The exfoliation body may be less rigid than the main body. The exfoliation body may include one or more exfoliation features. The one or more exfoliation features may be disposed on an exfoliation surface of the exfoliation body. The exfoliation surface may be opposite the exfoliation head from the interface.

Because the exfoliation head is bladeless, a user may be able to drag the exfoliation body across the skin without also causing a blade to be dragged across the skin. This may allow exfoliation and shaving to be performed separately, rather than concurrently, and as a result, the exfoliation performance can be improved and made more effective.

Because the exfoliation head is bladeless, a user may maneuver the exfoliation head as needed to accomplish exfoliation without risk of cutting the skin with a blade.

The exfoliation head may include at least one wear indicator.

The exfoliation head may include at least one pressure sensor. The pressure sensor may be configured to measure pressure applied to skin by way of the exfoliation head. The main body may provide structural integrity to the exfoliation head, and may allow forces from the user to be transmitted to the exfoliation body.

The exfoliation body may support the exfoliation surface. The exfoliation body may transform and transmit forces from the main body to the exfoliation surface.

The interface may allow the exfoliation head to be connected to a handle. This allows forces transmitted by the user to the handle to be transferred to the main body. As a result, the user may be able to maneuver the exfoliation head by way of a handle connected to the head. Connecting the exfoliation head to the handle may facilitate use of the exfoliation head.

Because the interface may allow for the exfoliation head to be detachably connected to the handle, a user may be able to disconnect the exfoliation head from the handle. As a result, the user may be able to reuse the same handle with multiple heads or may be able to use the same exfoliation head with multiple handles. The interface may allow for connection of the exfoliation head directly to the handle. In this way, it is possible for the structure of the exfoliation head to not be dependent on ancillary structures mounted on the handle.

If two objects of differing rigidity are subjected to the same force or stress, the less rigid of the two objects may exhibit a higher strain or deformation than the more rigid of the two objects. Because the exfoliation body may be less rigid than the main body, forces applied by a user in order to maneuver the exfoliation head on the skin may be reduced before they are transmitted to the skin. This force reduction may protect the skin from damage.

The exfoliation surface may support the exfoliation features.

The exfoliation features may transmit forces from the exfoliation body to the skin. In so doing, they may remove dirt, surface bacteria, dead skin cells, and/or sebum from the skin surface, and/or can prevent bumps by releasing trapped hair.

The exfoliation surface may extend to cover at least a portion of one or more side walls of the exfoliation body.

The exfoliation surface may include at least one lubricating element.

The exfoliation surface may be configured to be pivotably connected to the handle.

The main body may be formed of a first material, and the exfoliation body may be formed of a second material. One of the first and second materials may be softer than the other.

Using two materials may enable selection of a first material which may be well-suited for the role played by the main body, and a second material which may be well-suited for the role played by the exfoliation body.

If two materials of differing softness are subjected to the same stress, the softer of the two materials may exhibit higher strain than the less soft of the two materials.

By using one material that is softer than the other, it may be possible to fine-tune a rigidity relationship between the main body and the exfoliation body, such as the rigidity relationship described earlier herein, and/or it may be possible to protect the skin by absorbing excessive forces that could be applied by the user during the exfoliation process.

The first material may include a plastic. The plastic may include acrylonitrile butadiene styrene (ABS).

The second material may include a rubber. The rubber may include silicone rubber.

At least one exfoliation feature may include a proximal extremity connected to the exfoliation surface and a body extending towards a distal extremity of the at least one exfoliation feature.

As such, the at least one exfoliation feature may be easier to clean, and/or more effective at loosening or freeing ingrown hairs than reticulated, mesh, or textured exfoliation elements.

A separation distance between centers of proximal extremities of adjacent exfoliation features may be 1 to 10 mm (millimeters), or 2 to 6 mm, or 4 mm.

These separation distances may improve the efficiency of the exfoliation provided by the exfoliation head and/or improve safety for the skin during exfoliation.

The proximal extremity may have a diameter of 0.5 to 5 mm, or 1 to 3 mm, or 1.5 mm.

These proximal extremity diameters may improve the efficiency of the exfoliation provided by the exfoliation head and/or improve safety for the skin during exfoliation.

The body of the at least one exfoliation feature has a length of 0.5 to 10 mm, or 2.5 to 5 mm, or 3 mm.

These exfoliation feature lengths may improve the efficiency of the exfoliation provided by the exfoliation head and/or improve safety for the skin during exfoliation.

The at least one exfoliation feature may taper from the proximal extremity to the distal extremity.

A tapering geometry may provide a strong and/or stable base for an exfoliation feature. A tapering geometry may provide a narrow distal extremity and may improve an exfoliation feature's ability to loosen and/or liberate ingrown hair.

The distal extremity of the at least one exfoliation feature may present a rounded tip.

The rounded tip may be formed by a bulge in a distalmost surface at the distal extremity of the body.

The rounded tip may be a dome formed by converging lateral surface portions of the body. The rounded tip may be bulbous.

The rounded tip may increase safety for the skin during exfoliation and/or may prevent the skin from being scratched if excessive force is applied thereto.

The exfoliation body and/or the exfoliation surface thereof may present one or more massage features.

The one or more massage features may have a height, as measured from the exfoliation surface, which is similar or equivalent to a length of an exfoliation feature. The one or more massage features may have a width, as measured along the exfoliation surface, which is similar or equivalent to a major dimension of a proximal extremity of an exfoliation feature.

The one or more massage features may have a length, as measured along the exfoliation surface, of 5 to 100 mm, or 10 to 50 mm, or 35 mm.

The shape of the one or more massage features, as viewed perpendicular to the exfoliation surface, may be linear, curvilinear, undulating (regularly or irregularly), or even amorphous.

Each of the one or more massage features may have a uniform height and/or width and/or length, or may have a variable height and/or width and/or length. Height and/or length and/or width and/or shape may be uniform between plural massage features presented on a given exfoliation surface, or may vary from massage feature to massage feature. The one or more massage features may include the same material as a proximal and/or distal extremity of the one or more exfoliation features.

The one or more massage features may allow for a user to massage the skin during exfoliation. Massaging the skin during exfoliation may increase skin comfort during exfoliation. As a result, regular exfoliation may be incentivized.

The exfoliation surface may be delimited by rounded outline.

A rounded outline may be understood to include at least one rounded contour.

A rounded contour may be understood to mean a contour lacking vertices. Vertices, and more specifically sharp vertices, may cause discomfort if rubbed on skin. A rounded outline may be understood to lack vertices at least in a region in contact with skin. The absence of vertices may prevent discomfort to the skin. Additionally, the absence of vertices in contact with the skin may increase safety and/or ease of use of the exfoliation head.

A round outline may be understood to be completely lacking vertices. One example of a round outline is a circle.

An oval outline is an example of a round outline with one or two axes of symmetry.

The exfoliation surface may be convex, more specifically cylindrical or dome-shaped.

The exfoliation features may be arranged upright on the exfoliation surface.

“Upright on the exfoliation surface” may be understood to mean oblique or even substantially perpendicular to the exfoliation surface.

A convex exfoliation surface may facilitate exfoliation of bodily recesses, such as those typically found around joints of the face and limbs.

Alternatively, the exfoliation surface may be flat. A flat exfoliation surface may allow for a large number of exfoliation features to be put in contact with the skin at a given time.

The interface may include one or more protrusions to prevent the exfoliation surface from pivoting with respect to the handle.

As such, the exfoliation surface can be stabilized against the skin as the user maneuvers the exfoliation head. This may prevent the exfoliation body from rotating during maneuvering of the exfoliation head, which could cause the exfoliation surface to lose contact with the skin.

Preventing the exfoliation surface from pivoting may allow a user to apply stronger forces to the skin while maintaining a particular, desired orientation for at least one of the one or more exfoliation features with respect to the skin.

Alternatively, the interface may be pivotable with respect to the exfoliation surface.

As such, a user may be able to maneuver the exfoliation surface on a given section of skin for a wide range of interface positions. This may improve ergonomics of use.

The exfoliation head includes a vibration mechanism. The vibration mechanism includes an actuator. The actuator is disposed on the exfoliation head.

A vibration mechanism may provide a vibration function, which may improve exfoliation effectiveness by increasing the rigor of the exfoliation act.

Providing the exfoliation head with the actuator of the vibration mechanism may allow a user to use the vibration function even if an inexpensive non-vibrating handle were connected to the head.

The actuator may be located on the back of the exfoliation head. The actuator may be located on a lateral portion of the exfoliation head.

According to further examples of the disclosure a handheld skincare device may be provided. The skincare device may include an exfoliation head. The exfoliation head may be disposed on an extremity of a handle. The exfoliation head included by the skincare device may be a bladeless exfoliation head as described earlier herein.

The handle may have a connection portion. The connection portion may be configured to pivotably connect the exfoliation head to the handle.

Disposing the exfoliation head on an extremity of a handle may improve ergonomics and ease of use. A user may therefore be able to maneuver the exfoliation head easily on the skin. Additionally, disposing the exfoliation head on an extremity of a handle can improve visibility of the skin undergoing exfoliation, as the user's hand may be able to manipulate the exfoliation head at a distance using the handle.

Likewise, a skincare kit, or a shaving kit may be provided. The shaving kit may include a handle. The handle may be a razor handle. The shaving kit may include a shaving head. The shaving kit may include an exfoliation head. The exfoliation head may be an exfoliation head as described earlier herein. The handle may include a connector portion. The connector portion may be connectable to the shaving head. The connector portion may be connectable to the exfoliation head. The connector portion may be alternately connectable to the shaving head and the exfoliation head. The shaving head and/or the exfoliation head may be pivotable with respect to the handle when attached thereto.

Likewise, the shaving kit may include a skincare device. The skincare device may be a handheld skincare device as described earlier herein.

The handheld skincare device may have a connection portion configured to pivotably connect the exfoliation head to the handle.

Embodiments of the present disclosure may enhance shaving performance by reducing the abovementioned skin issues. This reduction may be made possible for at least the reason that exfoliation allows impurities to be driven away or otherwise removed prior to shaving. Additionally, the exfoliation may allow trapped hairs to be released, and may increase the closeness of the subsequent shave, all while preventing or reducing nicks and cuts. As a result, the shave can leave the skin softer, smoother and clearer (for example less irritated), at least as perceived by some users. Compared to exfoliation using a dedicated exfoliation device, the embodiments may be space-saving and lightweight, as well as inexpensive.

### BRIEF DESCRIPTION OF THE DRAWINGS

The disclosure may be more completely understood in consideration of the following detailed description of aspects of the disclosure in connection with the accompanying drawings, in which:

FIGS. 1A-D show exemplary outlines of the exfoliation body.

FIGS. 2A-D show a side sectional view of exemplary exfoliation surfaces.

FIGS. 3A-D show exemplary cross-sectional geometries of exfoliation features according to embodiments of the disclosure.

FIGS. 4A-D show exemplary exfoliation feature geometries in three dimensions according to embodiments of the disclosure.

FIGS. 5A-B show a tapered exfoliation feature in axial and oblique views, respectively.

FIG. 6 shows an exfoliation feature with a rounded tip.

FIGS. 7A-D show exfoliation bodies with massage features.

FIGS. 8A-C show skincare kits.

FIGS. 9A-B show handheld exfoliators.

FIG. 10 shows a front view of an exfoliation surface.

FIG. 11 shows an exemplary exfoliation feature.

While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

### DETAILED DESCRIPTION

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects and are not intended to limit the scope of the disclosure. The illustrative aspects depicted are intended only as exemplary.

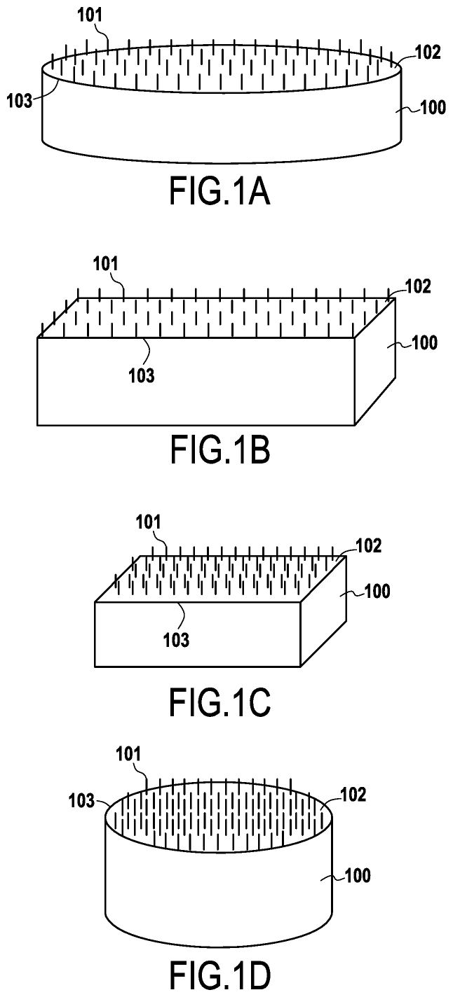

FIGS. 1A-D shows exemplary shapes of an exfoliation body 100 for an exfoliation head as discussed earlier herein. For example, the exfoliation body 100 may be delimited by a round outline 103, as can be seen in FIGS. 1A & 1D. The exfoliation body 100 may be delimited by a polygon in which one or more vertices is replaced by an arc tangential to adjacent line segments. The exfoliation body 100 may, according to some embodiments, be delimited by an outline 103 containing vertices, as seen in FIGS. 1B & 1C. An exfoliation body 100 delimited by an outline 103 including vertices may facilitate exfoliation of bodily recesses and/or hard-to-reach areas such the philtrum, mentolabial sulcus, nasolabial sulcus, and/or those near bony prominences of the knee or ankle.

As can be seen in FIGS. 1A-D the exfoliation body 100 presents exfoliation features 101 disposed on an exfoliation surface 102. The exfoliation features 101 may be of substantially uniform length (as shown in FIGS. 1A-D), or they may vary in length, such that one exfoliation feature 101 may be longer than another on the same exfoliation surface 102. Exfoliation feature geometry will be discussed in greater detail with regard to FIGS. 3A-D, 4A-D, 5A-B, 6 & 11.

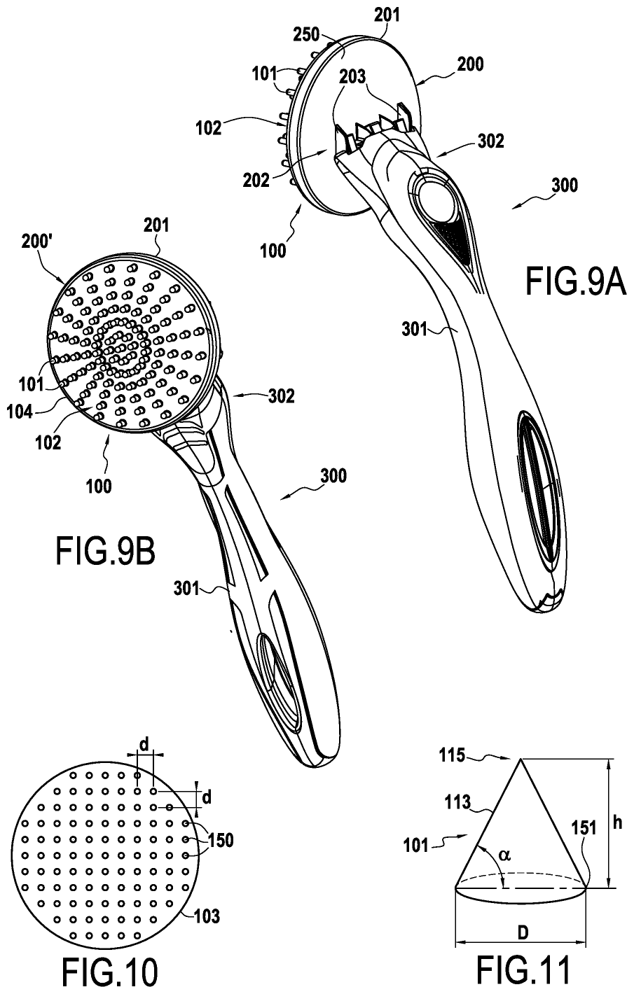

Additionally, as can be seen in FIGS. 1A-D, the packing density of exfoliation features 101 on the exfoliation surface 102 can be high (meaning the distance between adjacent exfoliation features 101 is small) or low (meaning the distance between adjacent exfoliation features 101 is large). Exfoliation feature 101 packing density may be substantially uniform across the exfoliation surface 102 (as shown in FIGS. 1A-D & 10), or it may be variable across the exfoliation surface 102 (as shown in FIG. 9B).

FIG. 10 shows a normal, schematic view of an exfoliation surface 102. The centers of proximal extremities of exfoliation features 101 are shown as points 150 within the outline 103 of the exfoliation surface 102. The separation distance “d” between adjacent points 150 represents the distance between centers of proximal extremities of adjacent exfoliation features 101. The separation distance “d” may be from 1 to 10 mm, or may be from 2 to 6 mm, or may be 4 mm, for example.

A small separation distance “d”, such as 1 mm or 2 mm, corresponds to a high packing density, whereas a large separation distance “d”, such as 6 mm or 10 mm, corresponds to a low packing density. 4 mm can be considered a moderate separation distance “d”, corresponding to a moderate packing density.

Although the separation distance “d” in FIG. 10 refers to a vertical and/or horizontal separation, the separation distance “d” could also be used to refer to a radial separation or even a separation in any direction.

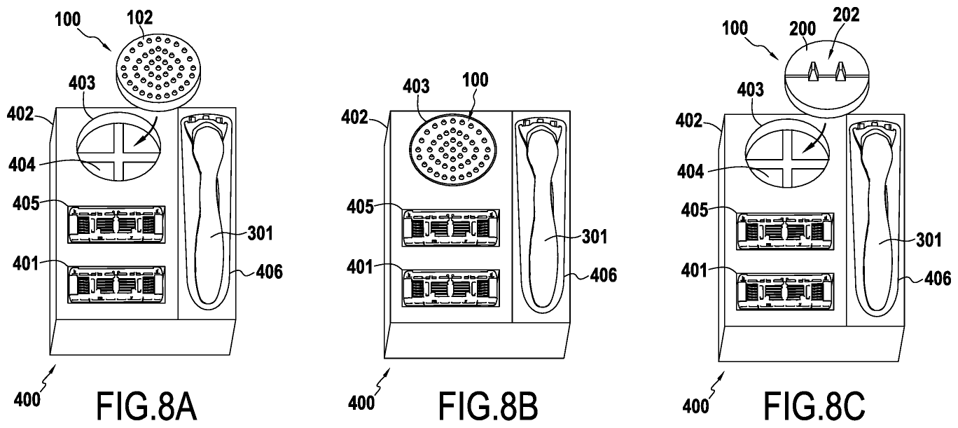

Although FIGS. 1B & 10 shows the exfoliation features 101 as being arranged in a grid-like pattern, with rows and columns, the exfoliation features 101 may also be arranged in a concentric and/or radiating pattern as shown in FIGS. 8A-B & 9B, or in a series of staggered parallel lines as shown in FIG. 1C or curves (not shown in the Figures), or along a series of curvilinear forms as in FIGS. 7B-D, or even in a semi-random or random arrangement. Moreover, a random or semi-random arrangement of exfoliation features 101 may be used in combination with one or more patterns of exfoliation features 101, and a given exfoliation surface 102 may even present multiple patterns of exfoliation features 101.

As can be seen in FIGS. 1A-D & 2B, the exfoliation surface 102 may be substantially flat. In FIGS. 1A-D & 2B, the exfoliation features 101 may be disposed upright on the exfoliation surface 102. In other words, at the proximal extremity of the exfoliation feature 101, the body of the exfoliation feature 101 may be substantially perpendicular to the exfoliation surface 102.

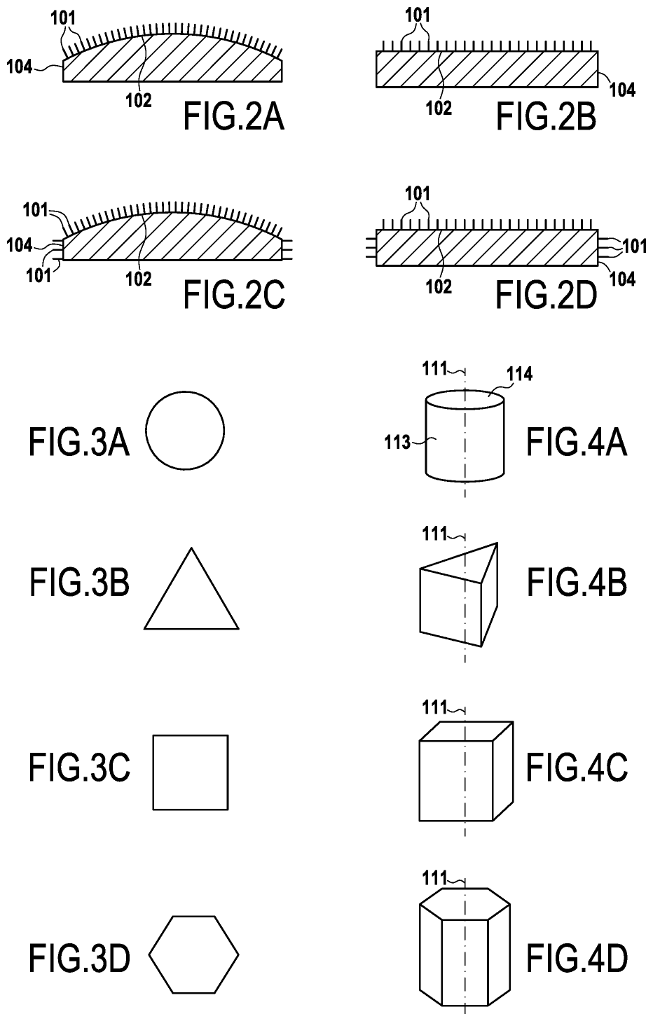

In FIG. 2A, the exfoliation surface 102 may be curved. Although FIG. 2A only shows curvature of the exfoliation surface 102 in one plane, as with a portion of a cylindrical surface (for example), the exfoliation surface 102 may be curved in two planes as with a portion of a spheroidal surface (for example).

Although such a configuration is not shown in the Figures, the exfoliation surface 102 may present both a curved portion and a flat portion.

Convex curvature may allow the exfoliation features 101 to engage the skin in bodily recesses, such as those found at or around the armpit, jaw, groin, chin cleft, ankle, cheek, kneecap, or larynx.

As shown in FIGS. 2C-D, the exfoliation surface 102 may extend to cover at least a portion of one or more side walls 104 of the exfoliation body 102. The exfoliation surface 102 on the side walls 104 may include exfoliation features 101. Alternatively, the exfoliation surface 102 on the side walls 104 may include one or more massage features 130. Massage features will be discussed in greater detail with regard to FIGS. 7A-D. Alternatively, the side walls 104 may be devoid of exfoliation features 101, as shown in FIGS. 2A-B.

As seen in FIG. 9B, a given side wall 104 may be arranged to extend, from at least a part of a periphery of the exfoliation surface 102, in a direction parallel to at least one exfoliation feature adjacent thereto, and may do so along a similar length as the at least one exfoliation feature. The portion of the side wall 104 extending from the (portion of the) periphery of the exfoliation surface 102 may include a rubber material.

The presence of exfoliation features 101, or massage features 130, or a rubber wall may serve for an improved cleaning of the skin (e.g. complete removal of dead skin cells).

As seen in FIGS. 2A-B, a curved exfoliation surface 102 may present exfoliation features 101 which are arranged upright thereon, so that the proximal extremity of a given exfoliation feature 101 is substantially perpendicular to the exfoliation surface 102 (as shown in FIGS. 2A & 2D), and/or the exfoliation features 101 on the exfoliation surface 101 may be arranged on the exfoliation surface 102 so that the proximal extremity of a given exfoliation feature 101 is oblique to the exfoliation surface 102 (as shown in FIG. 9B). Likewise, although not shown in the Figures, a flat exfoliation surface 102 may also present exfoliation features 101 which are arranged such that the proximal extremity of a given exfoliation feature 101 is arranged obliquely to the exfoliation surface 102.

As shown in FIGS. 3A-D, the body of the exfoliation feature 101 may have a wide range of cross-sectional geometries. For example, the cross-section may be round as in an ellipse, more specifically a circle (FIG. 3A). The cross-section may be polygonal (FIGS. 3B-D) as with a triangle (FIG. 3B), rectangle, more specifically square (FIG. 3C), pentagon, hexagon (FIG. 3D), etc.

As shown in FIGS. 4A-D, the body of the exfoliation feature 101 may be disposed along an axis 111. The axis 111 may be substantially straight along the entire length of the body. An exfoliation feature 101 having such a configuration is hereinafter referred to as an exfoliation pin.

Alternatively, the axis 111 may be curvilinear along at least a portion of the length of the body. An exfoliation feature 101 having such a configuration is hereinafter referred to as an exfoliation filament.

As shown in FIGS. 4A-D, the body of the exfoliation feature 101 may have a constant cross-sectional geometry, for example, in an exfoliation feature 101 shaped like a cylinder (FIG. 4A) or a prism (FIGS. 4B-D).

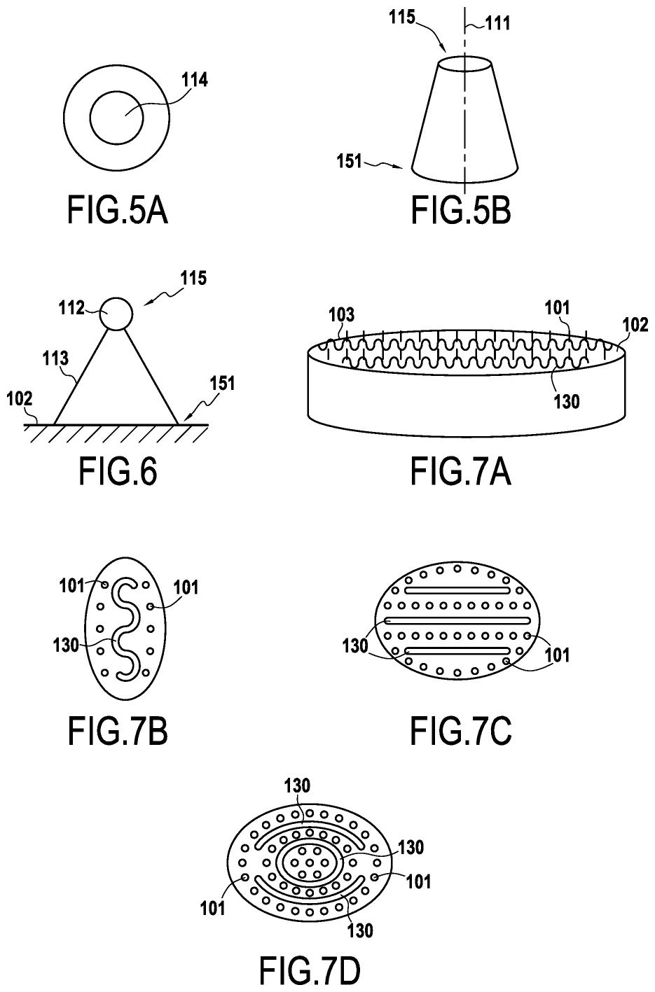

As shown in FIGS. 5A-B & 6, the body of the exfoliation feature 101 may have a variable cross-sectional geometry, for example, in an exfoliation feature 101 shaped like a pyramid or a cone (FIGS. 5A-B & 6).

An exfoliation pin may present a constant cross-sectional geometry, as with FIGS. 4A-D, or a variable geometry, as with FIGS. 5A-B & 6 for example. An exfoliation filament may alternatively present a variable cross-sectional geometry. Variability of cross-sectional geometry will be discussed in greater detail regarding FIG. 11.

An exfoliation feature 101 may include a portion with a constant geometry and a portion with variable geometry. In this regard, an exfoliation feature 101 that tapers from the proximal extremity 151 to the distal extremity 115 may, for example, taper in only a portion in of the body.

FIG. 11 shows an exfoliation feature 101 in perspective. The proximal extremity 151 of the exfoliation feature 101 may include a major dimension “D”. In the case of an exfoliation feature 101 having a circular cross-sectional geometry, the major dimension “D” can be understood to mean the diameter of the circle. In the case of an exfoliation feature 101 having a polygonal or non-circular geometry, the major dimension “D” can be understood to mean the diameter of a circle circumscribing the proximal extremity 151 or inscribed Within the proximal extremity 151. The magnitude of the major dimension “D” may determine the stability of the proximal extremity 151 of the exfoliation feature, with larger magnitudes corresponding to higher stability, at least in the direction in which the major dimension “D” is measured. The major dimension “D” may be from 0.5 to 5 mm, or may be from 1 to 3 mm, or may be, for example, 1.5 mm.

The exfoliation feature 101 includes an axis length “h”, which may correspond to the height of the exfoliation feature 101 relative to the exfoliation surface 102, in the case of an exfoliation pin, or to the arc length of the exfoliation feature 101 relative to the exfoliation surface 102, in the case of an exfoliation filament. The axis length “h” may be from 0.5 to 10 mm, or may be from 2.5 to 5 mm, or may be, for example, 3 mm.

The exfoliation feature 101 includes an angle “a”, which may correspond to the amount of taper.

As shown in FIG. 11, the angle “a” may be measured as the angle between a lateral surface 113 of the exfoliation feature 101 and a diameter of a circle inscribed within the proximal extremity 151 or circumscribing the proximal extremity 151.

The angle “α” may be from 5° (degrees) to 90°, or may be from 60° to 85° or may be, for example 75°. The value of the angle “α” for a given exfoliation feature 101 may be constant along the entire axis length “h” or variable. Moreover, the angle “α” can be made to vary between exfoliation features 101 on a given exfoliation surface 102, or the angle “α” can be identical from one exfoliation feature 101 to the next on a given exfoliation surface 102, so that they may taper in a uniform manner.

In contrast with FIGS. 4A-D & 5A-B, which show exfoliation features 101 in which the tip 112 is flat, FIG. 6 shows an exfoliation feature 101 with a rounded tip 112. A rounded tip 112 may be provided on an exfoliation feature 101 with a constant cross-sectional geometry or with a variable cross-sectional geometry.

The rounded tip 112 may be in the form of a bulbous knob, or a sphere, for example as shown in FIG. 6, which may extend beyond a lateral surface 113 of the exfoliation feature 101. The rounded tip 112 may be in the form of a dome (not shown in the Figures), as, for example, with a convex bulge in the distalmost surface 114 of the exfoliation feature 101, or as, for example, with convex curvilinear convergence of lateral surfaces 113 of the exfoliation feature 101.

Additionally, the exfoliation head 200 may include at least one lubricating element, which may be water-activated to provide a lubricating function on skin. For example, the lubricating element may be made of materials or mixtures of materials that reduce friction and/or provide lubrication when exposed to water. Non-limiting examples of lubricating elements can include water-soluble substances and/or water-insoluble substances, and/or soap and/or soap-based mixtures, and/or polymers able to reduce friction forces. Although the foregoing substances are presented as being possibly combinable with each other, they are also contemplated in isolation within a given lubricating element.

Non-limiting examples of relatively rigid water insoluble substances include polystyrene, styrene co-polymers, polyethylene, polypropylene, polyacetal, acrylonitrile-butadiene-styrene copolymer, ethylene vinyl acetal copolymer, polylactic acid, polycarbonate, maleic anhydride ethylene co-polymer blends, polyether-containing block copolymers (e.g. with polyamide), blends and copolymers of the above with or without other additives.

Non-limiting examples of relatively supple water insoluble substances include thermoplastic elastomer compounds (TPEs), for example thermoplastic poly-urethanes, and/or silicone polymers.

A relatively rigid water-insoluble substance may be understood to differ from a relatively supple water insoluble substance in that a given object made of the relatively rigid substance is significantly less deformable under typical pressures generated during exfoliation than if were made of the relatively supple substance.

Non-limiting examples of water soluble lubricating substances include polyethylene oxide and/or polyethylene glycol, polyvinyl pyrrolidone, polyacrylamide, polyhydroxymethacrylate, polyvinyl imidazoline, polyvinyl alcohol, polyhydromethymethacrylate, silicone polymers, blends and copolymers of the above.

Moreover, the exfoliation head 200 may include moisturizing elements to apply water and/or a moisturizing product on the skin and limit or avoid irritation. As a non-limiting example, the moisturizing element may be porous and/or may include a natural or synthetic sponge.

As shown in FIGS. 7A-D, the exfoliation body 100 may include one or more massage features 130. The one or more massage features may massage the skin during exfoliation, and may increase comfort as a result. The one or more massage features 130 may be disposed on the exfoliation surface 102. The massage features 130 may be made of the same material as the exfoliation surface 102. The one or more massage features 130 may even be formed as a single piece with the exfoliation surface 102. The one or more massage features 130 may have a length, as measured along the exfoliation surface 102, of 5 to 100 mm, or of 10 to 50 mm, or of 35 mm, for example.

The one or more massage features 130 may be interspersed amongst the exfoliation features 101, as seen in FIGS. 7A & 7C-D. Interspersing massage features 130 amongst the exfoliation features 101 may increase uniformity of comfort.

The one or more massage features 130 may also be separated from the exfoliation features 101, as seen in FIG. 7B. Although such an arrangement is not shown in the Figures, an exfoliation body 100 may present a massage feature 130 which is at least partially interspersed amongst the exfoliation features 101 and/or a massage feature 130 which is at least partially separated from the exfoliation features 101.

The massage feature 130 may be serpentine in shape, as shown in FIGS. 7A-B. The massage feature 130 may be linear in shape, as shown in FIG. 7C, or curved or rounded, as shown in FIG. 7D.

The shape of the massage feature 130 may determine the behavior of the massage feature 130 when in contact with the skin. As such, certain shapes of the massage feature(s) 130 may encourage a user to adopt a particular technique for maneuvering the exfoliation head on the skin, since the adopted technique may allow for a more comfortable and/or pleasing exfoliation experience.

For example, the linear shape shown in FIG. 7C may encourage a linear, back-and-forth technique, whereas the curved or rounded shapes shown in FIG. 7D may encourage a looping technique.

Through use of massage feature shape, it may be possible to guide the user to exfoliate effectively, by indicating through contact of the massage feature on the skin to indicate when the exfoliation head is being maneuvered optimally.

The exfoliation head 200 may include a wear indicator, for example a film or a strip that wears or loses mass due to mechanical abrasion caused by contacting the skin. As a result of such abrasion, the height of the wear indicator with respect to the exfoliation surface is reduced, for example so as to reveal a previously-concealed layer with a different color than the previously-concealing layer that had been abraded away, or may reveal the exfoliation surface underneath the wear indicator. Thus, the wear indicator may serve as an indication for the user to replace the exfoliation head. The wear indicator may be made of a polymer, for example polyethylene oxide (PEO) or other water-activated substances which increase in abradability when exposed to water, for example. The shape of the wear indicator may be similar to the exfoliation features 101. Alternatively, the shape of the wear indicator may be similar in shape to the massage features 130.

FIGS. 9A-B show exfoliation heads 200, 200′, each of whose main body 201 supports an exfoliation body 100 and an interface. The interface attaches the exfoliation head 200 to a handle 301, thus forming a handheld skincare device. The exfoliation head 200′ visible in FIG. 9B differs from the exfoliation head 200 visible in FIG. 9A by the extension of the side wall 104 visible in FIG. 9B.

The handle 301 may include a connector portion 302 for connecting the handle 301 to the interface of the exfoliation head 200. The connector portion 302 may be disposed at a distal extremity of the handle 301. Thus, the body of the handle 301, extending proximally therefrom, may be provided for manipulation by a user's hand.

A user may be able to place the exfoliation features 101 of the exfoliation surface 102 of the exfoliation body 100 of the exfoliation head 200 on the skin, and to exfoliate the skin easily by maneuvering the exfoliation head 200 on the skin via the handle 301.

According to embodiments of the disclosure, the exfoliation head 200, unlike a shaving head 401, is bladeless.

The handle 301 may be alternately connectable to the exfoliation head 200 and to some other sort of head, such as a shaving head 401. The handle 301 may have a connection portion 302 which allows the shaving head 401 to pivot with respect to the handle 301. The shaving head 401 may pivot from a rest position, in which the shaving head 401 is free of constraints towards two opposite directions. Alternatively, the shaving head 401 can pivot from a rest position towards one sole direction.

The shaving head 401 can pivot with regard to the handle 301 around a single pivot axis. Alternatively, the shaving head 401 can pivot with regard to the handle 301 around two or more pivot axes.

While some users may find such pivoting to be desirable when using a shaving head 401, they may not find such rotation to be desirable when using an exfoliation head 200. Since such users may already have a handle 301 at their disposal which provides such rotation for a shaving head 401, in FIG. 9A, the main body 201 of the exfoliation head 200 may include one or more protrusions 203 which may prevent rotation of the exfoliation body 101 retained in the main body 201 relative to the handle 301.

In examples, an exfoliation surface 102 that is pivotable relative to the handle 301 even when users may not enjoy using a shaving head 401 which is pivotable relative to the handle 301 may be foreseen. Since such users may already have a handle 301 at their disposal which does not offer pivoting of the shaving head 401, an unillustrated variant of the exfoliation head 200 may be provided, in which the interface is pivotable with respect to the exfoliation surface 102.

The exfoliation head 200 may pivot from a rest position, in which the exfoliation head 200 is free of constraints toward two opposite directions. Alternatively, the exfoliation head 200 can pivot from a rest position toward one sole direction.

The exfoliation head 200 can pivot with regard to the handle 301 around a single pivot axis. Alternatively, the shaving head 401 can pivot with regard to the handle 301 around two or more pivot axes.

The pivot mechanism that provides the pivoting to the exfoliation head 200 may be the same as the pivot mechanism that provides the pivoting to the shaving head 401. As a non-limiting example, the pivot mechanism may be similar to the one known from document WO2006027018A1, which is incorporated by reference herein. Alternatively, as a non-limiting example, the pivot mechanism may be similar to the one known from document WO2015128000A1, which is incorporated by reference herein. Additionally, as a non-limiting example, the pivoting function may be applied in more than one axis as known from document WO2017174120A1, which is incorporated by reference herein.

The main body 201 and the exfoliation body 101 of the exfoliation head 200 may be formed of different materials from one another. For example, the main body 201 may be formed of a comparatively hard or rigid plastic such as ABS, whereas the exfoliation body 101 may be formed of a comparatively soft or supple rubber-like material such as silicone.

The main body 201 and the exfoliation body 101 of the exfoliation head 200 may be manufactured through injection molding. The exfoliation features 101 may be formed of the same material as the exfoliation body 100. The exfoliation body may be co-injected on the main body. In this procedure, the main body may be injected into a mold in a first step, and subsequently the exfoliation body may be injected in a second step.

Although the main body 201 may include a first material and the exfoliation body 101 may include a second material, the main body 201 and exfoliation body 101 may alternatively be made of the same material as each other. In this case, it may be possible to make the exfoliation body 101 less rigid than the main body 201 through the use of relatively thin (and therefore relatively flexible) linkages and/or protrusions between the main body 201 and the exfoliation surface 102 in combination with relatively thick (and therefore relatively rigid) elements in the main body 201.

A user may exfoliate skin using the exfoliation head 200 by rubbing the exfoliation features 101 on the skin. The exfoliation features may be rubbed in any suitable fashion, for example a linear fashion, a curvilinear fashion, and/or even a circuitous fashion. The rubbing may be reciprocal (for example back-and-forth), cyclical (for example round-and-round), and/or even rotative (for example spinning).

To rub the exfoliation features 101 on the skin, and/or to maneuver the exfoliation head 200 on the skin, the user may apply forces to the main body 201 of the exfoliation head 200, typically using a handle 301 connected to the interface 202 of the exfoliation head 200.

Following exfoliation, the user may wish to clean the exfoliation head 200 to reduce or prevent microbial growth on the exfoliation surface 102 and the exfoliation features 101 (and massage features 130 where present).

To enhance exfoliation, the user may apply one or more chemicals or products to the skin. This application may be direct and/or via the exfoliation head 200. In this case, cleaning the exfoliation head 200 may also permit removal of products or chemicals added to the skin to facilitate exfoliation, which may have left residues on the exfoliation head 200.

The exfoliation head 200 may further include one or more sensors. Sensors may be used to detect the forces applied to a handle (for example by a user's hand) connected to the exfoliation head 200. Exemplary sensors may include one or more piezoelectric sensors, pressure sensors, temperature sensors, light sensors, pH sensors and/or conductance sensors. For example, piezoelectric sensors, pressure sensors, and/or conductance sensors may be used to detect when the exfoliation head 200 contacts the skin and/or the forces (pressure) the user may apply to the handle and eventually to the skin, during an exfoliation session. An indicator (for example a light) may be provided to warn the user when one or more measurements provided by the sensor(s) exceed a predefined limit, for example to encourage the user to reduce the force applied to the skin. Temperature sensors may be used to detect what is the skin temperature during the exfoliation session. More sensors may be located on the exfoliation head 200 to identify skin characteristics, skin elasticity, and/or skin irritation and facilitate and promote efficient shaving techniques for an improved shaving experience. A non-limiting example of a relevant mechanism and features of the sensing system are known from WO2019011523A1, which is incorporated by reference herein. The features of the sensing system may be located on the exfoliation head. Alternatively, the features of the sensing system may be located on the handle. Alternatively, the features of the sensing system may be located both on the handle and the exfoliation head.

FIGS. 8A-C show a skincare kit 400 including an exfoliation head 200. The skincare kit 400 may include a handle 301 for connecting to the exfoliation head. The skincare kit 400 may include a shaving head 401. The handle 201 may be alternately connectable to the exfoliation head 200 and the shaving head 401. The skincare kit 400 may include a dispenser 402 for housing and/or for dispensing one or more of the other components of the skincare kit 400.

As seen in FIG. 8A, the dispenser 402 may include a cavity 403 for receiving the exfoliation head 200. The cavity 403 may present drain holes 404 so that excess liquid may drain and may allow the exfoliation head 200 to dry. In this way, microbial growth may be discouraged in the interval between cleaning and reuse.

As seen in FIG. 8B, the exfoliation head 200 may be received in the dispenser 402 such that the exfoliation surface 102 faces out of the cavity 403. Such a configuration may facilitate drying of the exfoliation surface 102 by maximizing its exposure to air. Such a configuration may also allow for certain characteristics of the exfoliation surface 102 (such as its curvature and/or exfoliation features 101 and/or massage features 130) to be kept visible in retail packaging. In this way, a user may be able to identify his/her preferred model of exfoliation head 200 from a range of available models on a vendor's shelves.

As seen in FIG. 8C, the exfoliation head 200 may be received in the dispenser 402 such that the interface 202 faces out of the cavity 403. Because skincare kits may be stored in the bathroom, this configuration may discourage airborne contaminants from fouling the exfoliation surface 102 and exfoliation features 101. Additionally, such a configuration may allow for the interface 202 to be kept visible in retail packaging. In this way, a user may be able to determine which model of exfoliation head 200 from a range of available models on a vendor's shelves could be compatible with a given handle 301. Moreover, this configuration may allow a user to determine whether the exfoliation head 200 permits or prohibits rotation of the exfoliation surface 102 relative to the handle 301.

The cavity 403 may be configured to receive the exfoliation head 200 so that the exfoliation surface 102 faces out of the cavity (as in FIG. 8B) as well as so that the interface 200 faces out of the cavity (as in FIG. 8C).

A “shaving kit” is a type of skincare kit 400 that includes a shaving head 401. More specifically, a shaving kit includes a handle 301 and a shaving head 401. More specifically, the handle 301 can be a razor handle. The skincare kits 400 shown in FIGS. 8A-C may therefore also be shaving kits. The handle 301, which may be a razor handle, may be alternately connectable to the shaving head 401 and the exfoliation head 200.

For desirable results in terms of preventing shaving-related irritation, skin may be exfoliated as described earlier herein using the exfoliation head 200, prior to shaving. This sequence may lead to more effective exfoliation and therefore irritation prevention than exfoliating and shaving concurrently.

Shortly after exfoliation, the skin can be shaved. Because the irritation-preventing effects of exfoliation may diminish as time elapses between exfoliation and shaving, it is desirable to begin shaving within an hour of exfoliating, more specifically within 10 minutes of exfoliating, or more specifically within 2 minutes or even 1 minute of exfoliating for example. A user can be understood to have begun shaving from the moment s/he places a hair removal device (such as a shaving head 401, for example) or a chemical to be used in conjunction with the hair removal device (such as detergent or soap or a shaving cream or oil and the like, for example) on the skin. To facilitate this transition, the exfoliation head 200 may be detachably connected to the handle 301. Likewise, the handle 301 may be alternately connectable to the exfoliation head 200 and the shaving head 401.

Additionally, the alternate connectibility of the handle 301 to the exfoliation head 200 and the shaving head 401 may offer compactness and convenience, since the user may be able to shave and exfoliate using the same handle 301 and even the same gripping technique. The shaving kit may thus be more effective at preventing irritation than a shaving head with integrated exfoliation. Furthermore, because the exfoliation head 200 can be carried along with the shaving heads 401, use of the exfoliation head 200 for exfoliation may be more convenient than use of a dedicated exfoliation device which would need to be carried along with the razor. Moreover, exfoliation heads 200 may be considerably less expensive than dedicated exfoliation devices, which could make them easy to replace and cheaper to purchase than a dedicated exfoliation device.

To switch from the exfoliation function to the shaving function, a razor may be assembled using the same handle 301 used in the handheld skincare device 300. To disassemble the handheld skincare device 300, the exfoliation head 200 may be removed from the connector portion 302 of the handle 301. The razor may be assembled by installing the shaving head 401 on the connector portion 302 of the handle 301 after the exfoliation head 200 has been removed from the connector portion 302 of the handle 301.

After shaving, a user may leave the razor in an assembled state or a disassembled state. Likewise, a user may opt to assemble the handheld skincare device 300 so that it would be prepared in advance for exfoliation at a future date.

To prevent misplacement of the handle 301, a distributor 402 may be provided with a base 406 for supporting the handle 301. Although not pictured, the base 406 may include a space for accommodating the shaving head 401 on the handle 301, should the user opt to leave the razor in the assembled state. Likewise, although not pictured, the base 406 may include a space for accommodating the exfoliation head 200, should the user opt to switch from the shaving function to the exfoliating function and place the handheld skincare device 300 on the base 406. As shown in FIGS. 8A-C, the distributor 402 may be provided with a holder 405 for supporting the shaving head 401 when it is disconnected from the handle 301.

To switch from the shaving function to the exfoliation function, the handheld skincare device 300 may be assembled using the same handle 301 used in the razor. To disassemble the razor, the shaving head 401 may be removed from the connector portion 302 of the handle 301. The handheld skincare device 300 may be assembled by installing the exfoliation head 200 on the connector portion 302 of the handle 301 after the shaving head 401 has been removed from the connector portion 302 of the handle 301.

Although such an embodiment is not illustrated in the Figures, the exfoliation head 200 may include a vibration mechanism including an actuator. The actuator may be housed on the rear surface 250 of the main body 201 for example. A switch may be provided so that the user can activate and deactivate the motor. A power source, for example a rechargeable power source, may be provided to power the motor. The vibrations provided by the actuator of the vibration mechanism may enhance the exfoliation by providing gentle, small-scale motions of the exfoliation head 200 against the skin, and by providing these motions at a much higher frequency than would typically be feasible through manipulation of a handheld device through muscle action alone.

According to one variant, a handheld skincare 300 device may be provided with a vibration function via a vibration mechanism at least partially disposed in the handle 301. Provision of some or all of these elements in the handle 301 may allow for cheap and easy manufacturing, by taking advantage of space already available in the handle 301 by virtue of its size.

Although the described embodiments were provided as different exemplary embodiments, it is envisioned that these embodiments are combinable or, when not conflicting, the features recited in the described embodiments may be interchangeable.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A bladeless exfoliation head for a handheld skincare device, the exfoliation head comprising:
a main body supporting an exfoliation body and an interface for detachably connecting to a handle being less rigid than the main body and comprising one or more exfoliation features disposed on an exfoliation surface of the exfoliation body, the exfoliation surface being opposite the exfoliation head from the interface, wherein the exfoliation head further comprises a vibration mechanism including an actuator disposed on the exfoliation head.

2. The exfoliation head according to claim 1, wherein the exfoliation surface is configured to be pivotably connected to the handle.

3. The exfoliation head according to claim 1, wherein the main body is formed of a first material, and the exfoliation body is formed of a second material, and wherein one of the first and second materials is softer than the other.

4. The exfoliation head according to claim 1, wherein the exfoliation surface extends to cover at least a portion of one or more side walls of the exfoliation body.

5. The exfoliation head according to claim 1, wherein the exfoliation surface is delimited by a rounded outline.

6. The exfoliation head according to claim 1, wherein the exfoliation surface is convex, more specifically cylindrical or dome-shaped.

7. The exfoliation head according to claim 1, wherein the exfoliation surface further comprises at least one lubricating element.

8. The exfoliation head according to claim 1, wherein the exfoliation surface further presents one or more massage features.

9. The exfoliation head according to claim 1, wherein the exfoliation body includes one or more massage features, which are linear curvilinear, undulating, or amorphous, as viewed perpendicular to the exfoliation surface.

10. The exfoliation head according to claim 1, further comprising at least one wear indicator.

11. The exfoliation head according to claim 1, further comprising at least one pressure sensor, configured to measure pressure applied to skin by the exfoliation head.

12. The exfoliation head according to claim 1, wherein at least one exfoliation feature comprises a proximal extremity connected to the exfoliation surface and a body extending towards a distal extremity of the at least one exfoliation feature.

13. The exfoliation head according to claim 12, wherein a separation distance between centers of proximal extremities of adjacent exfoliation features is 1 to 10 mm.

14. The exfoliation head according to claim 12, wherein the proximal extremity has a major dimension of 0.5 to 5 mm.

15. The exfoliation head according to claim 12, wherein the body of the at least one exfoliation feature has a length of 0.5 to 10 mm.

16. The exfoliation head according to claim 12, wherein the body of the at least one exfoliation feature tapers from the proximal extremity to the distal extremity.

17. The exfoliation head according to claim 12, wherein the distal extremity of the at least one exfoliation feature presents a rounded tip.

18. (canceled)

19. A handheld skincare device comprising an exfoliation head according to claim 1, disposed on an extremity of a handle.

20. The handheld skincare device according to claim 19, wherein the handle has a connection portion configured to pivotably connect the exfoliation head to the handle.

21. A shaving kit comprising a handle, a shaving head and an exfoliation head according to claim 1, wherein the handle is a razor handle, comprising a connector portion that is alternately connectable to the shaving head and the exfoliation head, the connector portion configured to pivotably connect the shaving head or the exfoliation head such that the shaving or exfoliation head is pivotable with respect to the handle.
